(19) United States
(12) Patent Application Publication
(10) Pub. No.: US 2026/0120135 A1
(43) Pub. Date: Apr. 30, 2026

(54) INFORMATION PROCESSING APPARATUS, AND INFORMATION PROCESSING METHOD

(71) Applicant: NEC Corporation, Tokyo (JP)

(72) Inventors: You IWAKAMI, Tokyo (JP); Izumi KUWATA, Tokyo (JP); Mizuki IJIMA, Tokyo (JP); Riki ETO, Tokyo (JP)

(73) Assignee: NEC Corporation, Tokyo (JP)

(21) Appl. No.: 19/352,681

(22) Filed: Oct. 8, 2025

(30) Foreign Application Priority Data
Oct. 28, 2024 (JP) 2024-189294

(51) Int. Cl. G06Q 30/0202; G06Q 50/04

(52) U.S. Cl. CPC G06Q 30/02022; G06Q 50/04

(57) ABSTRACT

An information processing apparatus includes an acquisition unit that acquires feature values related to a target product and similar product information related to a product similar to the target product, a first prediction unit that calculates, by using a plurality of prediction models, a prediction value for each prediction model from the feature values, a selection unit that selects a metamodel related to the similar product information, and a second prediction unit that performs, by using the selected metamodel, prediction related to the target product from the prediction values calculated by the prediction models.

This application is based upon and claims the benefit of priority from Japanese Patent Application No. 2024-189294, filed on October 28, 2024, the disclosure of which is incorporated herein in its entirety by reference.

### TECHNICAL FIELD

The present disclosure relates to an information processing apparatus, and an information processing method.

### BACKGROUND ART

A technology for performing prediction related to a product is known. For example, JP 2020-98388 A discloses a prediction model for performing demand prediction of a new product. The prediction model described in JP 2020-98388 A generates, from an appearance frequency of a feature word extracted from each document in which an attribute of the new product is described, clustering information indicating a combination of degrees having the feature word, and is trained by using training data in which the clustering information is set as an explanatory variable and sales performance of an existing product is set as an objective variable.

### SUMMARY

In the technology described in JP 2020-98388 A, since the demand prediction of the new product is performed by using the one prediction model, prediction accuracy is degraded under a specific condition. Therefore, there is a demand for a technology for performing prediction related to a product with high accuracy regardless of conditions.

The present disclosure has been made in view of the above problem, and one exemplary object of the present disclosure is to provide a technology for performing prediction related to a product with high accuracy regardless of conditions.

An information processing apparatus according to one exemplary aspect of the present disclosure includes acquisition means for acquiring a plurality of feature values related to a target product and similar product information related to a product similar to the target product, first prediction means for calculating, by using a plurality of prediction models, a prediction value for each prediction model from the plurality of feature values, selection means for selecting a metamodel related to the similar product information from a plurality of trained metamodels trained for each product group, and second prediction means for performing, by using the selected metamodel, prediction related to the target product from the prediction values calculated by the plurality of prediction models.

An information processing apparatus according to one exemplary aspect of the present disclosure includes acquisition means for acquiring a plurality of feature values related to one or a plurality of products, first training means for training each of a plurality of prediction models for each of a plurality of feature value groups that is selected from the plurality of feature values and that includes one or a plurality of feature values, and second training means for training metamodels that relate to product groups each including one or a plurality of products and that perform prediction related to a target product with reference to output of the plurality of prediction models, with reference to output from the prediction models related to a plurality of feature value groups selected from a plurality of feature values related to the one or plurality of products included in the product group.

An information processing method according to one exemplary aspect of the present disclosure includes acquisition processing of acquiring, by at least one processor, a plurality of feature values related to a target product and similar product information related to a product similar to the target product, first prediction processing of calculating, by the at least one processor, a prediction value for each prediction model from the plurality of feature values, by using a plurality of prediction models, selection processing of selecting, by the at least one processor, a metamodel related to the similar product information from a plurality of trained metamodels trained for each product group, and second prediction processing of performing, by the at least one processor, prediction related to the target product from the prediction values calculated by the plurality of prediction models, by using the selected metamodel.

An information processing method according to one exemplary aspect of the present disclosure includes acquisition processing of acquiring, by at least one processor, a plurality of feature values related to one or a plurality of products, first training processing of training, by the at least one processor, each of a plurality of prediction models for each of a plurality of feature value groups that is selected from the plurality of feature values and that includes one or a plurality of feature values, and second training processing of training, by the at least one processor, metamodels that relate to product groups each including one or a plurality of products and that perform prediction related to a target product with reference to output of the plurality of prediction models, with reference to output from the prediction models related to a plurality of feature value groups selected from a plurality of feature values related to the one or plurality of products included in the product group.

An information processing program according to one exemplary aspect of the present disclosure is a program for causing a computer to function as an information processing apparatus, and the computer is caused to function as acquisition means for acquiring a plurality of feature values related to a target product and similar product information related to a product similar to the target product, first prediction means for calculating, by using a plurality of prediction models, a prediction value for each prediction model from the plurality of feature values, selection means for selecting a metamodel related to the similar product information from a plurality of trained metamodels trained for each product group, and second prediction means for performing, by using the selected metamodel, prediction related to the target product from the prediction values calculated by the plurality of prediction models.

An information processing program according to one exemplary aspect of the present disclosure is a program for causing a computer to function as an information processing apparatus, and the computer is caused to function as acquisition means for acquiring a plurality of feature values related to one or a plurality of products, first training means for training each of a plurality of prediction models for each of a plurality of feature value groups that is selected from the plurality of feature values and that includes one or a plurality of feature values, and second training means for training metamodels that relate to product groups each including one or a plurality of products and that perform prediction related to a target product with reference to output of the plurality of prediction models, with reference to output from the prediction models related to a plurality of feature value groups selected from a plurality of feature values related to the one or plurality of products included in the product group.

According to one exemplary aspect of the present disclosure, there is one exemplary effect that it is possible to provide a technology for performing prediction related to a product with high accuracy regardless of conditions.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration of an information processing apparatus according to the present disclosure;

FIG. 2 is a diagram illustrating an example of processing executed by the information processing apparatus according to the present disclosure;

FIG. 3 is a flowchart illustrating a flow of an information processing method according to the present disclosure;

FIG. 4 is a block diagram illustrating a configuration of an information processing apparatus according to the present disclosure;

FIG. 5 is a diagram illustrating an example of processing executed by a first training unit according to the present disclosure;

FIG. 6 is a diagram illustrating an example of processing executed by a second training unit according to the present disclosure;

FIG. 7 is a flowchart illustrating a flow of an information processing method according to the present disclosure;

FIG. 8 is a block diagram illustrating a configuration of a production management system according to the present disclosure;

FIG. 9 is a diagram illustrating an example of processing executed by an information processing apparatus according to the present disclosure;

FIG. 10 is a flowchart illustrating a flow of an information processing method according to the present disclosure;

FIG. 11 is a flowchart illustrating a flow of an information processing method according to the present disclosure;

FIG. 12A is a diagram illustrating an example of a prediction result provided by a provision unit according to the present disclosure;

FIG. 12B is a diagram illustrating an example of a prediction result provided by the provision unit according to the present disclosure;

FIG. 13 is a block diagram illustrating a configuration of a production management system according to the present disclosure; and

FIG. 14 is a block diagram illustrating a configuration of a computer that functions as an information processing apparatus according to the present disclosure.

### EXAMPLE EMBODIMENT

Hereinafter, example embodiments of the present disclosure will be exemplified. However, the present disclosure is not limited to the following example embodiments, and various modifications can be made within the scope set in the claims. For example, example embodiments obtained by appropriately combining technologies (some or all of things or methods) adopted in the following example embodiments can also be included in the scope of the present disclosure. Example embodiments obtained by appropriately omitting some of the technologies adopted in the following example embodiments can also be included in the scope of the present disclosure. Effects mentioned in the following example embodiments are examples of effects expected in the example embodiments, and do not define extension of the present disclosure. That is, example embodiments that do not achieve the effects mentioned in the following example embodiments can also be included in the scope of the present disclosure.

### First Exemplary Example Embodiment

A first example embodiment that is an example of the example embodiments of the present disclosure will be described in detail with reference to the drawings. The present example embodiment is a basic form of each of the example embodiments described below. An application range of each technology adopted in the present example embodiment is not limited to the present example embodiment. That is, each technology adopted in the present example embodiment can also be adopted in another example embodiment included in the present disclosure within a range in which no particular technical problem occurs. Each technology illustrated in the drawings referred to for description of the present example embodiment can also be adopted in another example embodiment included in the present disclosure within a range in which no particular technical problem occurs.

### Configuration of Information Processing Apparatus 1

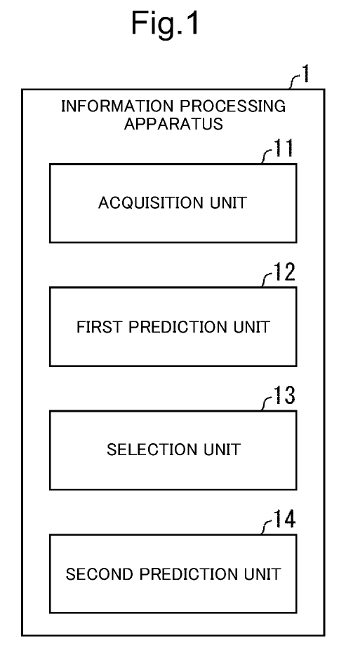

A configuration of an information processing apparatus 1 will be described with reference to FIG. 1. FIG. 1 is a block diagram illustrating the configuration of the information processing apparatus 1. As illustrated in FIG. 1, the information processing apparatus 1 includes an acquisition unit 11, a first prediction unit 12, a selection unit 13, and a second prediction unit 14. The acquisition unit 11, the first prediction unit 12, the selection unit 13, and the second prediction unit 14 achieve acquisition means, first prediction means, selection means, and second prediction means in the present example embodiment.

### Acquisition Unit 11

The acquisition unit 11 acquires a plurality of feature values related to a target product and similar product information related to a product similar to the target product. The acquisition unit 11 supplies the acquired plurality of feature values to the first prediction unit 12. The acquisition unit 11 supplies the acquired similar product information to the selection unit 13.

### First Prediction Unit 12

The first prediction unit 12 calculates, by using a plurality of prediction models, a prediction value for each prediction model from a plurality of feature values supplied from the acquisition unit 11. The first prediction unit 12 supplies the calculated prediction values to the second prediction unit 14.

### Selection Unit 13

The selection unit 13 selects a metamodel related to similar product information supplied from the acquisition unit 11 from a plurality of trained metamodels trained for each product group.

### Second Prediction Unit 14

The second prediction unit 14 performs, by using a metamodel selected by the selection unit 13, prediction related to a target product from prediction values calculated by a plurality of prediction models.

### Example of Processing Executed by Information Processing Apparatus 1

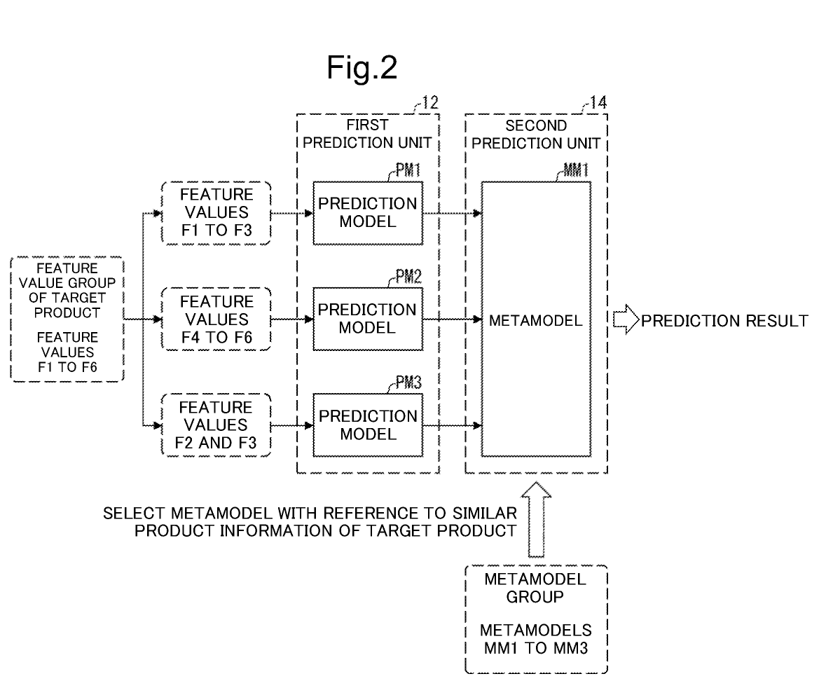

An example of processing executed by the information processing apparatus 1 will be described with reference to FIG. 2. FIG. 2 is a diagram illustrating an example of the processing executed by the information processing apparatus 1.

The acquisition unit 11 acquires a feature value group including a plurality of feature values F1 to F6 related to a target product and similar product information.

The first prediction unit 12 calculates a prediction value 1 by inputting the feature values F1 to F3 included in the feature value group to a prediction model PM1. Similarly, the first prediction unit 12 calculates a prediction value 2 by inputting the feature values F4 to F6 included in the feature value group to a prediction model PM2. The first prediction unit 12 calculates a prediction value 3 by inputting the feature values F2 and F3 included in the feature value group to a prediction model PM3.

The selection unit 13 selects a metamodel MM1 related to the similar product information with reference to the similar product information acquired by the acquisition unit 11 from a metamodel group including a plurality of metamodels MM1 to MM3 trained for each product group. In other words, the selection unit 13 selects the metamodel MM1 related to a product group to which a product indicated by the similar product information belongs.

The second prediction unit 14 performs, by using the metamodel MM1 selected by the selection unit 13, prediction related to the target product from the prediction values 1 to 3 calculated by the prediction models PM1 to PM3.

### Effect of Information Processing Apparatus 1

As described above, the information processing apparatus 1 adopts the configuration including the acquisition unit 11 that acquires a plurality of feature values related to a target product and similar product information related to a product similar to the target product, the first prediction unit 12 that calculates, by using a plurality of prediction models, a prediction value for each prediction model from the plurality of feature values supplied from the acquisition unit 11, the selection unit 13 that selects a metamodel related to the similar product information supplied from the acquisition unit 11 from a plurality of trained metamodels trained for each product group, and the second prediction unit 14 that performs, by using the metamodel selected by the selection unit 13, prediction related to the target product from the prediction values calculated by the plurality of prediction models.

In this manner, according to the information processing apparatus 1, the prediction related to the target product is performed by using the prediction value for each prediction model from the plurality of feature values. According to the information processing apparatus 1, the prediction related to the target product is performed from the prediction values calculated by the plurality of prediction models, by using the metamodel related to a product group similar to the target product. Therefore, according to the information processing apparatus 1, it is possible to obtain an effect that the prediction related to the product can be performed with high accuracy regardless of conditions.

### Achievement Example by Information Processing Program

In a case where the information processing apparatus 1 is configured by a computer including at least one processor and a memory, the following program is stored in the memory. The information processing program is a program for causing the computer to function as the information processing apparatus 1, and causes the computer to function as the acquisition unit 11 that acquires a plurality of feature values related to a target product and similar product information related to a product similar to the target product, the first prediction unit 12 that calculates, by using a plurality of prediction models, a prediction value for each prediction model from the plurality of feature values supplied from the acquisition unit 11, the selection unit 13 that selects a metamodel related to the similar product information supplied from the acquisition unit 11 from a plurality of trained metamodels trained for each product group, and the second prediction unit 14 that performs, by using the metamodel selected by the selection unit 13, prediction related to the target product from the prediction values calculated by the plurality of prediction models.

### Flow of Information Processing Method S1

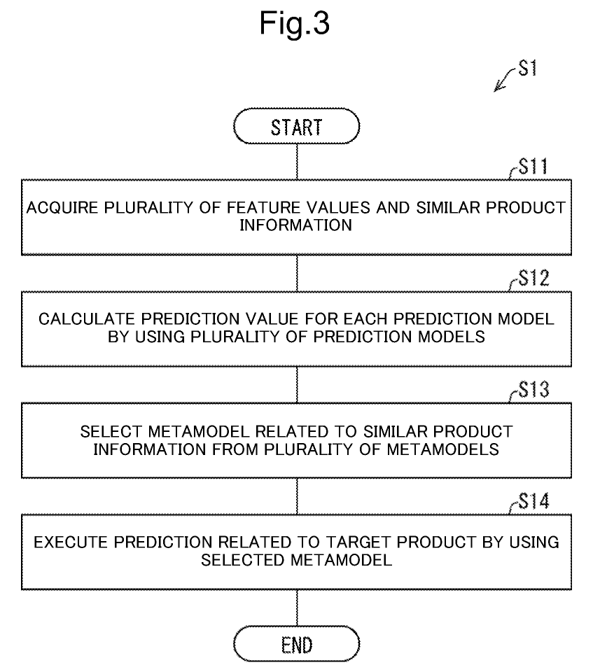

A flow of an information processing method S1 will be described with reference to FIG. 3. FIG. 3 is a flowchart illustrating the flow of the information processing method S1. As illustrated in FIG. 3, the information processing method S1 includes acquisition processing S11, first prediction processing S12, selection processing S13, and second prediction processing S14.

### Acquisition Processing S11

In the acquisition processing S11, the acquisition unit 11 acquires a plurality of feature values related to a target product and similar product information related to a product similar to the target product. The acquisition unit 11 supplies the acquired plurality of feature values to the first prediction unit 12. The acquisition unit 11 supplies the acquired similar product information to the selection unit 13.

### First Prediction Processing S12

In the first prediction processing S12, the first prediction unit 12 calculates, by using a plurality of prediction models, a prediction value for each prediction model from the plurality of feature values supplied from the acquisition unit 11. The first prediction unit 12 supplies the calculated prediction values to the second prediction unit 14.

### Selection Processing S13

In the selection processing S13, the selection unit 13 selects a metamodel related to the similar product information supplied from the acquisition unit 11 from a plurality of trained metamodels trained for each product group.

### Second Prediction Processing S14

In the second prediction processing S14, the second prediction unit 14 performs, by using the metamodel selected by the selection unit 13, prediction related to the target product from the prediction values calculated by the plurality of prediction models.

### Effect of Information Processing Method S1

As described above, the information processing method S1 adopts the configuration including the acquisition processing S11 in which the acquisition unit 11 acquires a plurality of feature values related to a target product and similar product information related to a product similar to the target product, the first prediction processing S12 in which the first prediction unit 12 calculates, by using a plurality of prediction models, a prediction value for each prediction model from the plurality of feature values supplied from the acquisition unit 11, the selection processing S13 in which the selection unit 13 selects a metamodel related to the similar product information supplied from the acquisition unit 11 from a plurality of trained metamodels trained for each product group, and the second prediction processing S14 in which the second prediction unit 14 performs, by using the metamodel selected by the selection unit 13, prediction related to the target product from the prediction values calculated by the plurality of prediction models. Therefore, according to the information processing method S1, an effect similar to that of the information processing apparatus 1 described above can be obtained.

### Configuration of Information Processing Apparatus 2

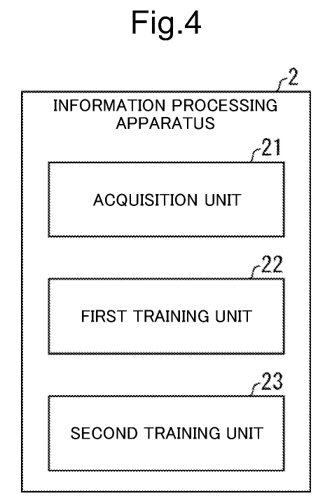

A configuration of an information processing apparatus 2 will be described with reference to FIG. 4. FIG. 4 is a block diagram illustrating the configuration of the information processing apparatus 2. As illustrated in FIG. 4, the information processing apparatus 2 includes an acquisition unit 21, a first training unit 22, and a second training unit 23. The acquisition unit 21, the first training unit 22, and the second training unit 23 achieve acquisition means, first training means, and second training means in the present example embodiment.

### Acquisition Unit 21

The acquisition unit 21 acquires a plurality of feature values related to one or a plurality of products. The acquisition unit 21 supplies the acquired plurality of feature values to the first training unit 22.

### First Training Unit 22

The first training unit 22 trains each of a plurality of prediction models for each of a plurality of feature value groups that is selected from feature values supplied from the acquisition unit 21 and that includes one or a plurality of feature values.

### Second Training Unit 23

The second training unit 23 trains metamodels that relate to product groups each including one or a plurality of products and that perform prediction related to a target product with reference to output of a plurality of prediction models trained by the first training unit 22, with reference to output from the prediction models related to a plurality of feature value groups selected from a plurality of feature values related to the one or plurality of products included in the product group.

### Example of Processing Executed by First Training Unit 22

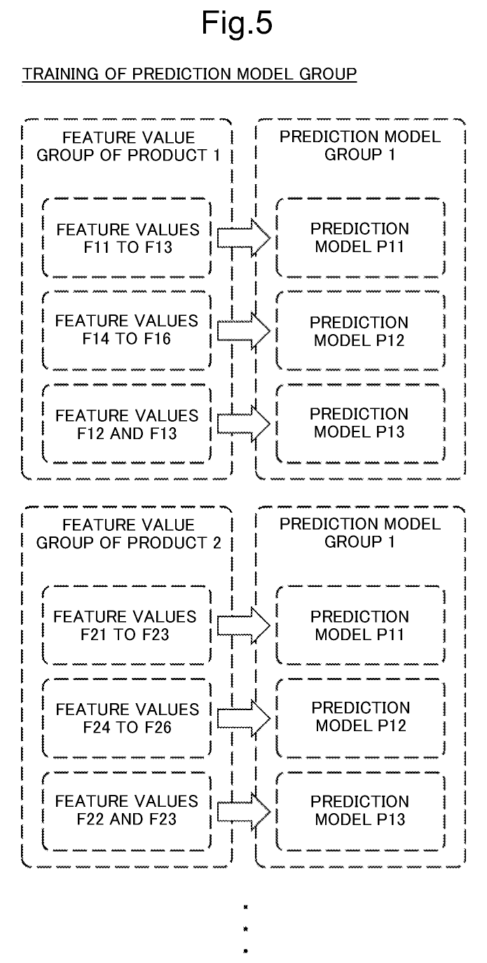

An example of processing executed by the first training unit 22 will be described with reference to FIG. 5. FIG. 5 is a diagram illustrating an example of the processing executed by the first training unit 22.

In FIG. 5, the feature values supplied from the acquisition unit 21 are a feature value group including feature values F11 to F16 of a product 1 and a feature value group including feature values F21 to F26 of a product 2. As illustrated in FIG. 5, each feature value group includes a plurality of feature value groups each including one or a plurality of feature values.

For example, the feature value group of the product 1 includes a feature value group including the feature values F11 to F13, a feature value group including the feature values F14 to F16, and a feature value group including the feature values F12 and F13. The feature value group of the product 2 includes a feature value group including the feature values F21 to F23, a feature value group including the feature values F24 to F26, and a feature value group including the feature values F22 and F23. A relationship between the products 1 and 2 is not particularly limited, but as an example, the products 1 and 2 are products belonging to the same product group.

As illustrated in FIG. 5, the feature value included in each feature value group is not particularly limited, and for example, there may be the feature value included in the plurality of feature value groups in an overlapping manner, such as the feature value F12.

The number of feature values included in each feature value group is also not particularly limited.

As illustrated in FIG. 5, the first training unit 22 trains a prediction model P11 included in a prediction model group 1 by using the feature value group including the feature values F11 to F13 of the product 1. Similarly, the first training unit 22 trains a prediction model P12 included in the prediction model group 1 by using the feature value group including the feature values F14 to F16 of the product 1. The first training unit 22 also trains a prediction model P13 included in the prediction model group 1 by using the feature value group including the feature values F12 and F13 of the product 1.

Also for the product 2, as illustrated in FIG. 5, the first training unit 22 trains the prediction model P11 included in the prediction model group 1 by using the feature value group including the feature values F21 to F23 of the product 2. Similarly, the first training unit 22 trains the prediction model P12 included in the prediction model group 1 by using the feature value group including the feature values F24 to F26 of the product 2. The first training unit 22 also trains the prediction model P13 included in the prediction model group 1 by using the feature value group including the feature values F22 and F23 of the product 2.

The first training unit 22 may train a prediction model group different from the prediction model group 1 by using the feature value group of the product 2. In this case, the first training unit 22 may train a prediction model group 2 by using a plurality of feature value groups in which a combination of included feature values is different from that of the feature values described above.

### Example of Processing Executed by Second Training Unit 23

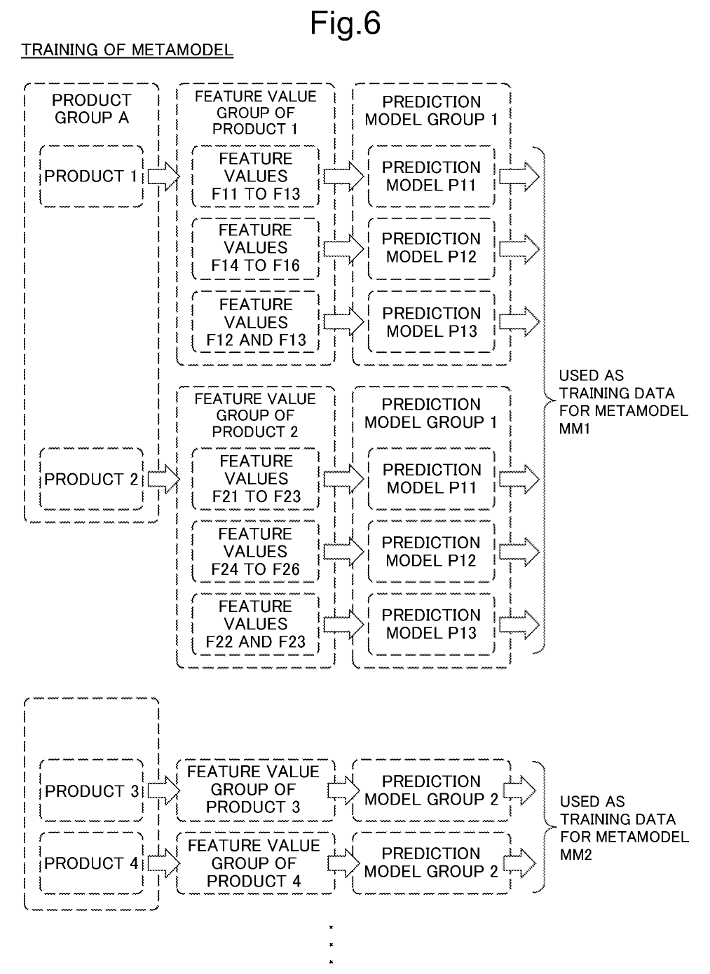

An example of processing executed by the second training unit 23 will be described with reference to FIG. 6. FIG. 6 is a diagram illustrating an example of the processing executed by the second training unit 23.

In the present example, a case is assumed where the first training unit 22 has trained the prediction model group 1 by the method illustrated in FIG. 5 described above, for the products 1 and 2 belonging to a product group A. A case is also assumed where the first training unit 22 has trained each of prediction models included in the prediction model group 2 for each of a plurality of feature value groups selected from feature values of each of products 3 and 4 belonging to a product group B, for the products 3 and 4.

In this case, as illustrated in FIG. 6, the second training unit 23 trains, by using output in a case where the feature value groups of the product 1 are input to the prediction model group 1 as training data, the metamodel MM1 that relates to the product group A and that performs prediction related to a product belonging to the product group A with reference to output of the prediction model group 1.

More specifically, the second training unit 23 trains the metamodel MM1 with reference to output in a case where the feature value group including the feature values F11 to F13 of the product 1 is input to the prediction model P11, output in a case where the feature value group including the feature values F14 to F16 of the product 1 is input to the prediction model P12, and output in a case where the feature value group including the feature values F12 and F13 of the product 1 is input to the prediction model P13.

Also for the product 2, the second training unit 23 trains the metamodel MM1 with reference to output in a case where the feature value group including the feature values F21 to F23 of the product 2 is input to the prediction model P11, output in a case where the feature value group including the feature values F24 to F26 of the product 2 is input to the prediction model P12, and output in a case where the feature value group including the feature values F22 and F23 of the product 2 is input to the prediction model P13.

Also for the product group B, the second training unit 23 similarly trains the metamodel MM2 related to the product group B.

That is, the second training unit 23 trains, by using output in a case where feature value groups of the product 3 are input to the prediction model group 2 as training data, the metamodel MM2 that relates to the product group B and performs prediction related to a product belonging to the product group B with reference to output of the prediction model group 2.

Also for the product 4, the second training unit 23 trains the metamodel MM2 by using output in a case where feature value groups of the product 4 are input to the prediction model group 2 as training data.

### Effect of Information Processing Apparatus 2

As described above, the information processing apparatus 2 adopts the configuration including the acquisition unit 21 that acquires a plurality of feature values related to one or a plurality of products, the first training unit 22 that trains each of a plurality of prediction models for each of a plurality of feature value groups that is selected from the feature values supplied from the acquisition unit 21 and that includes one or a plurality of feature values, and the second training unit 23 that trains metamodels that relate to product groups each including one or a plurality of products and that perform prediction related to a target product with reference to output of the plurality of prediction models trained by the first training unit 22, with reference to output from the prediction models related to a plurality of feature value groups selected from a plurality of feature values related to the one or plurality of products included in the product group.

In this manner, according to the information processing apparatus 2, it is possible to suitably train the metamodels that relate to the product groups and that perform prediction related to the target product with reference to the output of the plurality of prediction models trained by using the feature values of the products. Therefore, according to the information processing apparatus 2, similarly to the information processing apparatus 1 described above, it is possible to obtain an effect that prediction related to the product can be performed with high accuracy regardless of conditions.

### Achievement Example by Information Processing Program

In a case where the information processing apparatus 2 is configured by a computer including at least one processor and a memory, the following program is stored in the memory. The information processing program is the program for causing the computer to function as the information processing apparatus 2, and causes the computer to function as the acquisition unit 21 that acquires a plurality of feature values related to one or a plurality of products, the first training unit 22 that trains each of a plurality of prediction models for each of a plurality of feature value groups that is selected from the feature values supplied from the acquisition unit 21 and that includes one or a plurality of feature values, and the second training unit 23 that trains metamodels that relate to product groups each including one or a plurality of products and that perform prediction related to a target product with reference to output of the plurality of prediction models trained by the first training unit 22, with reference to output from the prediction models related to a plurality of feature value groups selected from a plurality of feature values related to the one or plurality of products included in the product group.

### Flow of Information Processing Method S2

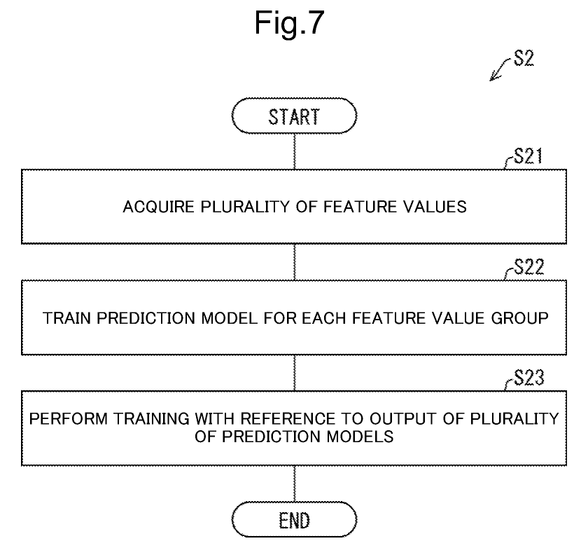

A flow of an information processing method S2 will be described with reference to FIG. 7. FIG. 7 is a flowchart illustrating the flow of the information processing method S2. As illustrated in FIG. 7, the information processing method S2 includes acquisition processing S21, first training processing S22, and second training processing S23.

### Acquisition Processing S21

In the acquisition processing S21, the acquisition unit 21 acquires a plurality of feature values related to one or a plurality of products. The acquisition unit 21 supplies the acquired plurality of feature values to the first training unit 22.

### First Training Processing S22

In the first training processing S22, the first training unit 22 trains each of a plurality of prediction models for each of a plurality of feature value groups that is selected from the feature values supplied from the acquisition unit 21 and that includes one or a plurality of feature values.

### Second Training Processing S23

In the second training processing S23, the second training unit 23 trains metamodels that relate to product groups each including one or a plurality of products and that perform prediction related to a target product with reference to output of the plurality of prediction models trained by the first training unit 22, with reference to output from the prediction models related to a plurality of feature value groups selected from a plurality of feature values related to the one or plurality of products included in the product group.

### Effect of Information Processing Method S2

As described above, the information processing method S2 adopts the configuration including the acquisition processing S21 in which the acquisition unit 21 acquires a plurality of feature values related to one or a plurality of products, the first training processing S22 in which the first training unit 22 trains each of a plurality of prediction models for each of a plurality of feature value groups that is selected from the feature values supplied from the acquisition unit 21 and that includes one or a plurality of feature values, and the second training processing S23 in which the second training unit 23 trains metamodels that relate to product groups each including one or a plurality of products and that perform prediction related to a target product with reference to output of the plurality of prediction models trained by the first training unit 22, with reference to output from the prediction models related to a plurality of feature value groups selected from a plurality of feature values related to the one or plurality of products included in the product group. Therefore, according to the information processing method S2, an effect similar to that of the information processing apparatus 2 described above can be obtained.

### Second Exemplary Example Embodiment

A second example embodiment that is an example of the example embodiments of the present disclosure will be described in detail with reference to the drawings. Components having the same functions as the components described in the example embodiment described above are denoted by the same reference signs, and description thereof will be appropriately omitted. An application range of each technology adopted in the present example embodiment is not limited to the present example embodiment. That is, each technology adopted in the present example embodiment can also be adopted in another example embodiment included in the present disclosure within a range in which no particular technical problem occurs. Each technology illustrated in each of the drawings referred to for description of the present example embodiment can also be adopted in another example embodiment included in the present disclosure within a range in which no particular technical problem occurs.

### Configuration and Outline of Production Management System 100A

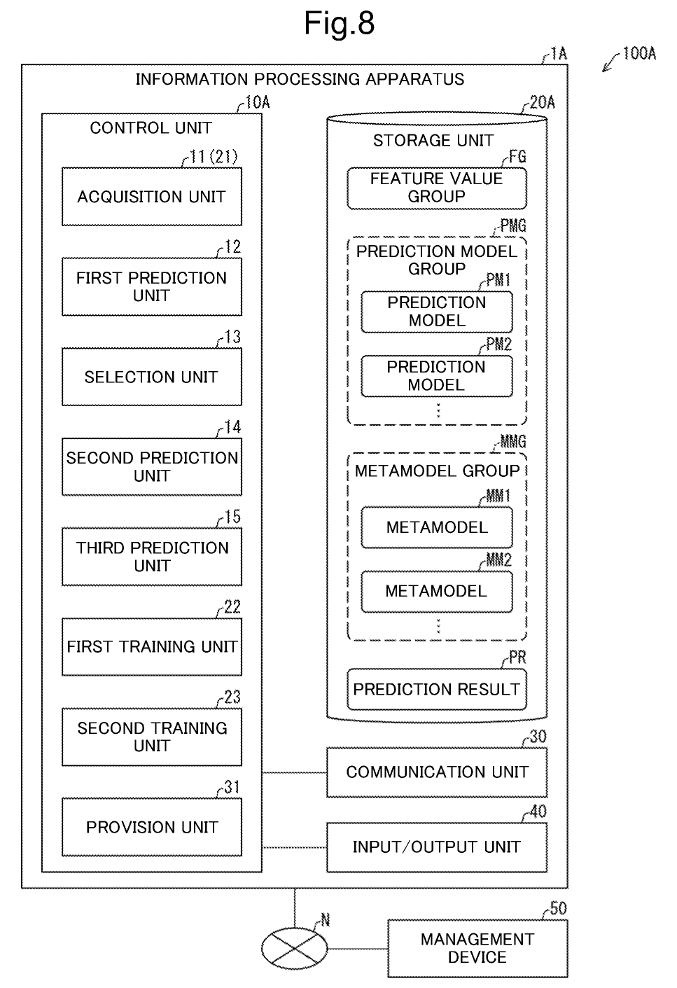

A configuration and an outline of a production management system 100A will be described with reference to FIG. 8. FIG. 8 is a block diagram illustrating the configuration of the production management system 100A. As illustrated in FIG. 8, the production management system 100A includes an information processing apparatus 1A and a management device 50. The information processing apparatus 1A and the management device 50 are communicably connected via a network N.

A specific configuration of the network N is not particularly limited, but as an example, a wireless local area network (LAN), a wired LAN, a wide area network (WAN), a public line network, a mobile data communication network, or a combination of these networks can be used.

The production management system 100A is a system that manages production of a target product according to a product group to which the target product belongs. More specifically, in the production management system 100A, the information processing apparatus 1A performs prediction related to the target product according to the product group to which the target product belongs, and the management device 50 manages the production of the target product based on the prediction by the information processing apparatus 1A.

The product group is not particularly limited, and examples thereof include a mineral water group, a tea group, and a coffee group in the case of a beverage. Other examples of the product group include a shirt group, a bottom group, and a jacket group in the case of clothing.

That is, in the production management system 100A, for example, in a case where the target product belongs to the mineral water group, the production of the target product according to the mineral water group is managed, and in a case where the target product belongs to the tea group, the production of the target product according to the tea group is managed. The target product may be a product already on the market or a new product that has not been on the market yet.

Examples of a method of managing the production of the target product by the management device 50 include, but are not limited to, notifying a production manager of information related to a prediction result of a demand of the target product in the market, ordering a raw material of the target product by using an order system, and managing inventory.

### Configuration of Information Processing Apparatus 1A

A configuration of the information processing apparatus 1A will be described with reference to FIG. 8 again. As illustrated in FIG. 8, the information processing apparatus 1A includes a control unit 10A, a storage unit 20A, a communication unit 30, and an input/output unit 40.

### Storage Unit 20A

The storage unit 20A stores data to be referred to by the control unit 10A. Examples of the data stored in the storage unit 20A include, but are not limited to, a feature value group FG, a prediction model group PMG, a metamodel group MMG, and a prediction result PR.

The feature value group FG includes a plurality of feature values F of the target product, which indicates features of the target product and affects the prediction related to the target product performed by the information processing apparatus 1A. The feature value F included in the feature value group FG is also referred to as a key driver (KD).

The feature value group FG includes a plurality of feature value groups each including one or a plurality of the feature values F. Each of the plurality of feature value groups relates to each of a plurality of prediction models PM included in the prediction model group PMG to be described below. An example of the feature value group will be described below.

The prediction model group PMG includes the plurality of prediction models PM each of which outputs a prediction value related to the target product. As described above, each of the plurality of prediction models PM relates to each of the plurality of feature value groups. More specifically, each of the plurality of prediction models PM calculates the prediction value related to the target product by using the related feature value group as input. In other words, each of the plurality of prediction models PM is a model trained for each feature value group including one or a plurality of the feature values F.

With this configuration, for example, the information processing apparatus 1A can use the plurality of prediction models PM each of which performs prediction according to the feature value group, such as a prediction model PM trained by using a feature value group related to a content of a product and a prediction model PM trained by using a feature value group related to an external environment. Therefore, the information processing apparatus 1A can increase accuracy of the prediction.

The metamodel group MMG includes a plurality of metamodels MM each related to a product group. In other words, each of the plurality of metamodels MM included in the metamodel group MMG is a trained metamodel trained for each product group.

Each of the plurality of metamodels MM included in the metamodel group MMG may be, for example, a regression model that outputs a prediction value of a demand of the target product, or the like, or a classification model that outputs whether the demand of the target product is larger or smaller than a predetermined value, or the like.

As an example, each of the plurality of metamodels MM is a metamodel trained to predict the demand of the target product from the prediction value of the demand of the target product calculated by each of the plurality of prediction models PM. In other words, each of the plurality of metamodels MM predicts the demand of the target product from the prediction value calculated by each of the plurality of prediction models PM.

With this configuration, the information processing apparatus 1A can predict the demand of the target product regardless of conditions of the target product, for example, predicting a demand of a new product that has not been on the market yet.

The prediction result PR indicates a prediction result by a second prediction unit 14 to be described below.

### Communication Unit 30

The communication unit 30 is an interface for transmitting and receiving data via the network. Examples of the communication unit 30 include, but are not limited to, communication chips in various communication standards such as Ethernet, Wi-Fi, and wireless communication standards of mobile data communication networks, and connectors compliant with USB.

### Input/Output Unit 40

The input/output unit 40 is an interface with an input device that receives input of data and an output device that outputs data. Examples of the input device include, but are not limited to, a microphone, a camera, a line-of-sight input device, a keyboard, and a touch pad. Examples of the output device include, but are not limited to, another device (for example, the management device 50), a speaker, and a liquid crystal display. The input/output unit 40 may be the input device and the output device.

### Control Unit 10A

The control unit 10A controls each component included in the information processing apparatus 1A. As illustrated in FIG. 8, the control unit 10A includes an acquisition unit 11 (21), a first prediction unit 12, a selection unit 13, the second prediction unit 14, a third prediction unit 15, a first training unit 22, a second training unit 23, and a provision unit 31. The acquisition unit 11 (21), the first prediction unit 12, the selection unit 13, the second prediction unit 14, the third prediction unit 15, the first training unit 22, the second training unit 23, and the provision unit 31 achieve acquisition means, first prediction means, selection means, second prediction means, third prediction means, first training means, second training means, and provision means in the present example embodiment. An example of processing executed by each unit will be described below.

### Acquisition Unit 11 (21)

The acquisition unit 11 (21) acquires data supplied from the communication unit 30 or the input/output unit 40. The acquisition unit 11 (21) stores the acquired data in the storage unit 20A.

As an example, the acquisition unit 11 (21) acquires the plurality of feature values F (feature value group FG) related to the target product. In addition to the feature value group FG, the acquisition unit 11 (21) acquires similar product information related to a product similar to the target product.

### First Prediction Unit 12

The first prediction unit 12 calculates, by using the plurality of prediction models PM (prediction model group PMG), the prediction value for each prediction model PM from the plurality of feature values F. The first prediction unit 12 supplies the calculated prediction values to the second prediction unit 14.

More specifically, the first prediction unit 12 inputs each of the plurality of feature value groups including one or a plurality of the feature values F to each of the plurality of prediction models PM. The first prediction unit 12 then calculates the prediction value for each prediction model PM with reference to the output of each of the plurality of prediction models PM.

### Selection Unit 13

The selection unit 13 selects a metamodel MM related to the similar product information from the metamodel group MMG. The selection unit 13 supplies information indicating the selected metamodel MM to the second prediction unit 14.

More specifically, the selection unit 13 selects, from the metamodel group MMG, the metamodel MM related to a product group to which the product indicated by the similar product information belongs. In other words, the metamodel MM selected by the selection unit 13 is a metamodel trained by using a plurality of feature values F of a product belonging to the same product group as the product group to which the product indicated by the similar product information belongs.

### Second Prediction Unit 14

The second prediction unit 14 performs, by using the metamodel MM selected by the selection unit 13, prediction related to the target product from the prediction value calculated by each of the plurality of prediction models PM of the prediction model group PMG. The second prediction unit 14 stores the prediction result PR in the storage unit 20A.

More specifically, the second prediction unit 14 inputs the prediction value calculated by each of the plurality of prediction models PM of the prediction model group PMG to the metamodel MM selected by the selection unit 13. The second prediction unit 14 then performs the prediction related to the target product with reference to output of the metamodel MM.

### Third Prediction Unit 15

The third prediction unit 15 predicts a product similar to the target product, and generates similar product information. The third prediction unit 15 stores the generated similar product information in the storage unit 20A.

As an example, the third prediction unit 15 predicts the product similar to the target product by using a similarity determination model. Examples of the similarity determination model include a model trained to output a decision making result reflecting an intention of a person skilled in processing of determining a product similar to a target product. Such a similarity determination model is generated by being trained by using teacher data including a plurality of sets of state data indicating a state for determining the product similar to the target product and action data indicating a decision making result that is an action executed in the state indicated by the state data. In this case, the third prediction unit 15 inputs information indicating the target product to the similarity determination model, and generates similar product information indicating the similar product indicated by the output decision making result.

With this configuration, the information processing apparatus 1A can suitably generate the similar product information even in a case where the similar product information cannot be acquired.

### First Training Unit 22

The first training unit 22 trains each of the plurality of prediction models PM of the prediction model group PMG for each of the plurality of feature value groups that is selected from the feature value group FG and that includes one or a plurality of the feature values F.

### Second Training Unit 23

The second training unit 23 trains the metamodels MM that relate to the product groups each including one or a plurality of products and that perform prediction related to the target product with reference to the output of the prediction model group PMG trained by the first training unit 22, with reference to output from the prediction models PM related to a plurality of feature value groups selected from the plurality of feature values F related to the one or plurality of the products included in the product group.

### Provision Unit 31

The provision unit 31 provides the prediction result PR by the second prediction unit 14. As an example, the provision unit 31 provides the prediction result PR by the second prediction unit 14 to the management device 50 that performs production management of the target product. As another example, the provision unit 31 provides the prediction result PR via the input/output unit 40.

### Example of Processing Executed by Information Processing Apparatus 1A

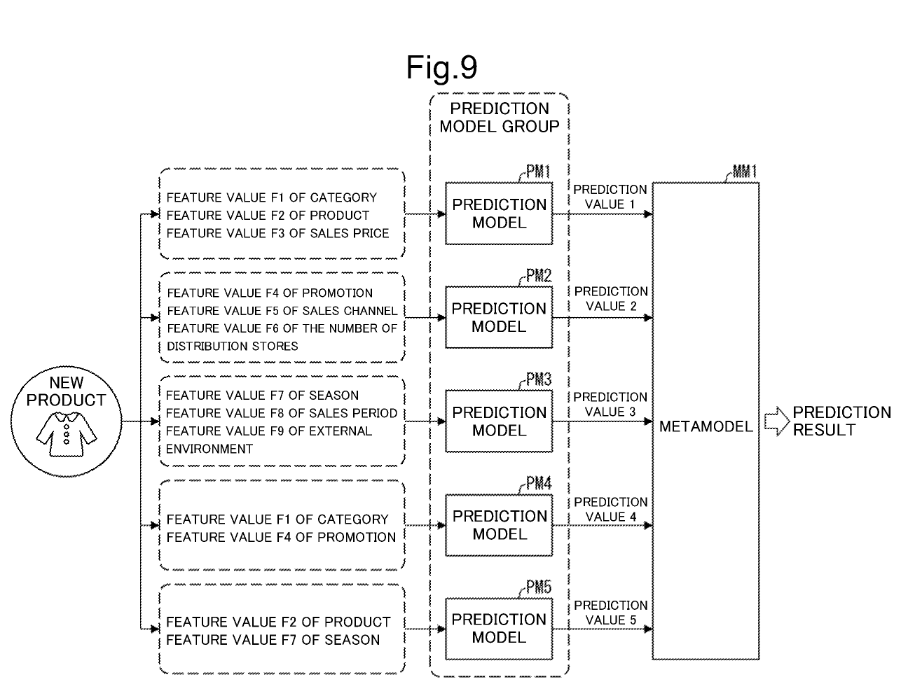

An example of processing executed by the information processing apparatus 1A will be described with reference to FIG. 9. FIG. 9 is a diagram illustrating an example of the processing executed by the information processing apparatus 1A. Hereinafter, as an example, a case where the information processing apparatus 1A predicts a demand of a new product in the market will be described.

First, the acquisition unit 11 (21) acquires a plurality of feature values F1 to F9 related to the new product. The feature values F1 to F9 are the following feature values.

Feature value F1: a feature value of a category of the new product, feature value F2: a feature value of a product of the new product, feature value F3: a feature value of a sales price of the new product, feature value F4: a feature value of promotion of the new product, feature value F5: a feature value of a sales channel of the new product, feature value F6: a feature value of the number of distribution stores of the new product, feature value F7: a feature value of a season in which the new product is sold, feature value F8: a feature value of a sales period of the new product, and feature value F9: a feature value of an external environment in sales of the new product

Next, the first prediction unit 12 inputs a feature value group related to each of the prediction models PM to each of the prediction models PM, and supplies output prediction values to the second prediction unit 14. For example, as illustrated in FIG. 9, the first prediction unit 12 inputs the following feature value groups to the related prediction models PM, and supplies the output prediction values to the second prediction unit 14.

A feature value group including the feature values F1 to F3 is input to a prediction model PM1, and an output prediction value 1 is supplied to the second prediction unit 14.

A feature value group including the feature values F4 to F6 is input to a prediction model PM2, and an output prediction value 2 is supplied to the second prediction unit 14.

A feature value group including the feature values F7 to F9 is input to a prediction model PM3, and an output prediction value 3 is supplied to the second prediction unit 14.

A feature value group including the feature values F1 and F4 is input to a prediction model PM4, and an output prediction value 4 is supplied to the second prediction unit 14.

A feature value group including the feature values F2 and F7 is input to a prediction model PM5, and an output prediction value 5 is supplied to the second prediction unit 14.

Subsequently, the selection unit 13 selects a metamodel MM related to similar product information from the metamodel group MMG. For example, in a case where a similar product indicated by the similar product information is a “shirt group”, the selection unit 13 selects a metamodel MM1 related to the product group “shirt group”.

The second prediction unit 14 inputs the prediction values 1 to 5 supplied from the first prediction unit 12 to the metamodel MM1 selected by the selection unit 13, and stores the output prediction result PR in the storage unit 20A.

The provision unit 31 provides the prediction result PR by the second prediction unit 14 to the management device 50 that performs production management of the target product.

### Example 1 of Flow of Processing Executed by Information Processing Apparatus 1A

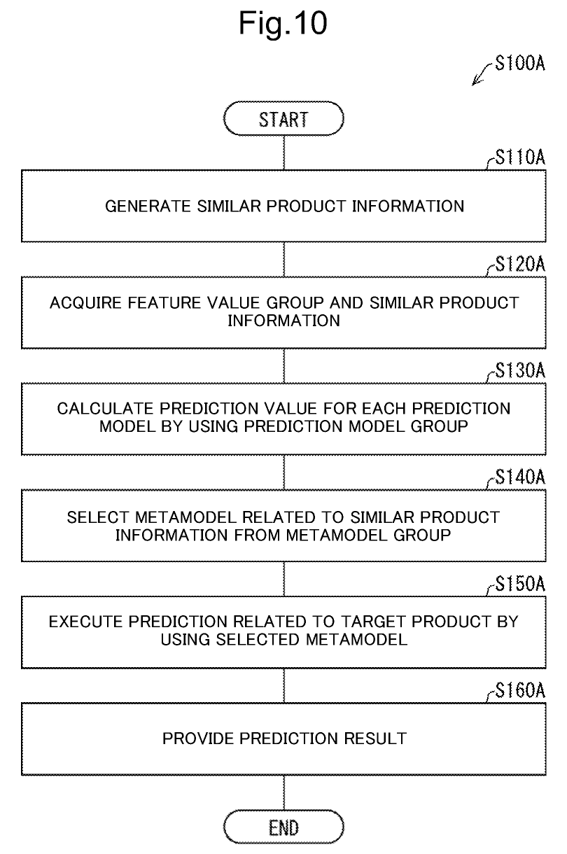

An example of a flow of processing (an information processing method S100A) executed by the information processing apparatus 1A will be described with reference to FIG. 10. FIG. 10 is a flowchart illustrating a flow of the information processing method S100A. Hereinafter, processing in which the information processing apparatus 1A predicts a demand of a target product will be described.

### Step S110A: Third Prediction Processing

In step S110A, the third prediction unit 15 predicts a product similar to the target product, and generates similar product information. The third prediction unit 15 stores the generated similar product information in the storage unit 20A.

### Step S120A: Acquisition Processing

In step S120A, the acquisition unit 11 (21) acquires the plurality of feature values F (feature value group FG) related to the target product and the similar product information related to the product similar to the target product.

The acquisition unit 11 (21) may acquire the similar product information generated in step S110A described above, or may acquire the similar product information supplied from the communication unit 30 or the input/output unit 40.

### Step S130A: First Prediction Processing

In step S130A, the first prediction unit 12 calculates, by using the plurality of prediction models PM (prediction model group PMG), the prediction value for each prediction model PM from the plurality of feature values F. The first prediction unit 12 supplies the calculated prediction values to the second prediction unit 14.

### Step S140A: Selection Processing

In step S140A, the selection unit 13 selects a metamodel MM related to the similar product information from the metamodel group MMG. The selection unit 13 supplies information indicating the selected metamodel MM to the second prediction unit 14.

### Step S150A: Second Prediction Processing

In step S150A, the second prediction unit 14 performs, by using the metamodel MM selected by the selection unit 13, prediction related to the target product from the prediction value calculated by each of the plurality of prediction models PM of the prediction model group PMG. The second prediction unit 14 stores the prediction result PR in the storage unit 20A.

### Step S160A: Provision Processing

In step S160A, the provision unit 31 provides the prediction result PR by the second prediction unit 14 to the management device 50 that performs production management of the target product.

### Example 2 of Flow of Processing Executed by Information Processing Apparatus 1A

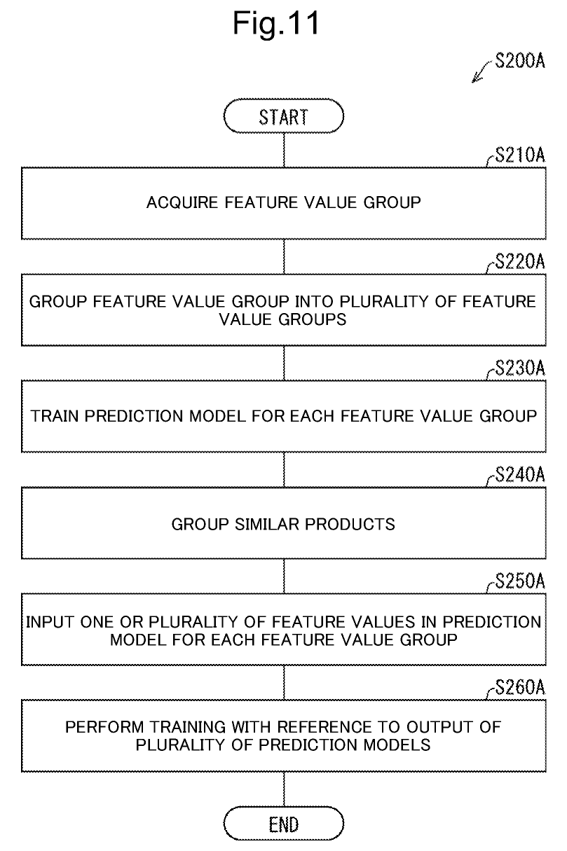

Another example of the flow of the processing (an information processing method S200A) executed by the information processing apparatus 1A will be described with reference to FIG. 11. FIG. 11 is a flowchart illustrating a flow of the information processing method S200A. Hereinafter, in addition to FIG. 11, processing in which the information processing apparatus 1A trains the prediction models PM and the metamodels MM will be described with reference to FIGS. 5 and 6 again.

### Step S210A: Acquisition Processing

In step S210A, the acquisition unit 11 (21) acquires the plurality of feature values F (feature value group FG) related to the target product. For example, the acquisition unit 11 (21) acquires the feature value group (feature values F11 to F16) of the product 1 and the feature value group (feature values F21 to F26) of the product 2 illustrated in FIG. 5. The acquisition unit 11 (21) stores the acquired feature value groups FG in the storage unit 20A.

### Step S220A

In step S220A, the first training unit 22 groups the feature values F included in the feature value groups FG acquired by the acquisition unit 11 (21) into the plurality of feature value groups related to the plurality of prediction models PM.

For example, as illustrated in FIG. 5, the first training unit 22 groups the feature values F included in the feature value group FG of the product 1 into the following feature value groups.

The feature value group related to the prediction model P11 and including the feature values F11 to F13, the feature value group related to the prediction model P12 and including the feature values F14 to F16, and the feature value group related to the prediction model P13 and including the feature values F12 and F13

Similarly, as illustrated in FIG. 5, the first training unit 22 groups the feature values F included in the feature value group FG of the product 2 into the following feature value groups.

The feature value group related to the prediction model P11 and including the feature values F21 to F23, the feature value group related to the prediction model P12 and including the feature values F24 to F26, and the feature value group related to the prediction model P13 and including the feature values F22 and F23

### Step S230A: First Training Processing

In step S230A, the first training unit 22 trains each of the plurality of prediction models PM of the prediction model group PMG for each feature value group grouped in step S220A.

For example, for the product 1, as illustrated in FIG. 5, the first training unit 22 trains the prediction model P11 by using the feature value group including the feature values F11 to F13. More specifically, the first training unit 22 trains the prediction model P11 in such a way that a prediction value output in a case where the feature value group including the feature values F11 to F13 is input to the prediction model P11 becomes a demand of the product 1 having features indicated by the feature values F11 to F13.

Similarly, the first training unit 22 trains the prediction model P12 by using the feature value group including the feature values F14 to F16, and trains the prediction model P13 by using the feature value group including the feature values F12 and F13.

Also for the product 2, as illustrated in FIG. 5, the first training unit 22 trains the prediction model P11 by using the feature value group including the feature values F21 to F23, trains the prediction model P12 by using the feature value group including the feature values F24 to F26, and trains the prediction model P13 by using the feature value group including the feature values F22 and F23.

The first training unit 22 may train a prediction model group 2 different from the prediction model group 1 by using the feature value group of the product 2. In this case, the first training unit 22 may train a prediction model group 2 by using a plurality of feature value groups in which a combination of included feature values is different from that of the feature values described above.

### Step S240A

In step S240A, the second training unit 23 groups similar products for products related to the feature value groups acquired by the acquisition unit 11 (21) in step S210A.

For example, as illustrated in FIG. 6, in a case where the acquisition unit 11 (21) acquires the feature value groups of the products 1 to 4 in step S210A, the second training unit 23 groups similar products among the products 1 to 4. Examples of a method for determining whether a plurality of products is similar to each other include, but are not limited to, a method using the similarity determination model described above.

In a case where the products 1 and 2 are similar among the products 1 to 4 (in a case where the products 1 and 2 belong to the product group A), the second training unit 23 groups the products 1 and 2.

In a case where the products 3 and 4 are similar among the products 1 to 4 (in a case where the products 3 and 4 belong to the product group B), the second training unit 23 groups the products 3 and 4.

### Step S250A

In step S250A, the second training unit 23 first groups the feature values F included in the feature value group FG into a plurality of feature value groups related to the plurality of prediction models PM for each product belonging to the product group grouped in step S240A, similarly to the first training unit 22 in step S220A described above.

For example, as illustrated in FIG. 6, the second training unit 23 groups the feature values F included in the feature value group FG of the product 1 belonging to the product group A into the following feature value groups.

The feature value group related to the prediction model P11 and including the feature values F11 to F13, the feature value group related to the prediction model P12 and including the feature values F14 to F16, and the feature value group related to the prediction model P13 and including the feature values F12 and F13

Also for the product 2 belonging to the product group A, as illustrated in FIG. 6, the second training unit 23 groups the feature values F included in the feature value group FG into the following feature value groups.

The feature value group related to the prediction model P11 and including the feature values F21 to F23, the feature value group related to the prediction model P12 and including the feature values F24 to F26, and the feature value group related to the prediction model P13 and including the feature values F22 and F23

The second training unit 23 then inputs one or a plurality of the feature values F for each feature value group to the prediction models PM.

For example, for the product 1, as illustrated in FIG. 6, the second training unit 23 inputs the feature value group including the feature values F11 to F13 to the prediction model P11, and acquires a prediction value output from the prediction model P11. Similarly, the second training unit 23 inputs the feature value group including the feature values F14 to F16 to the prediction model P12, and acquires a prediction value output from the prediction model P12. The second training unit 23 also inputs the feature value group including the feature values F12 and F13 to the prediction model P13, and acquires a prediction value output from the prediction model P13.

Also for the product 2, the second training unit 23 inputs the feature value group including the feature values F21 to F23 to the prediction model P11, and acquires a prediction value output from the prediction model P11. Similarly, the second training unit 23 inputs the feature value group including the feature values F24 to F26 to the prediction model P12, and acquires a prediction value output from the prediction model P12. The second training unit 23 also inputs the feature value group including the feature values F22 and F23 to the prediction model P13, and acquires a prediction value output from the prediction model P13.

In this manner, in the training processing by the second training unit 23, one or a plurality of the feature values F included in each of the plurality of feature value groups selected from the feature value groups FG related to one or a plurality of the products (products 1 and 2) included in the product group A is input to each of the prediction models P11 to P13. With this configuration, since the second training unit 23 acquires the prediction values output by inputting, to the plurality of prediction models P11 to P13, the feature value groups that relate to the feature value groups used for training of the prediction models P11 to P13 and that relate to one or a plurality of the products, it is possible to acquire highly accurate prediction values.

Similarly for the product group B, for each of the products 3 and 4 belonging to the product group B, the feature values F included in the feature value group FG are grouped into the plurality of feature value groups related to the plurality of prediction models of the prediction model group 2. The second training unit 23 then inputs one or a plurality of the feature values F for each feature value group to the prediction models PM, and acquires the prediction values.

### Step S260A: Second Training Processing

In step S260A, the second training unit 23 trains the metamodels MM with reference to the output (prediction values) of the plurality of prediction models PM acquired in step S250A. As an example, the second training unit 23 trains the metamodels MM by using a regression method (for example, ElasticNet).

For example, for the product 1 belonging to the product group A, as illustrated in FIG. 6, the second training unit 23 trains the metamodel MM1 related to the product group A by using, as training data, the prediction value output from the prediction model P11, the prediction value output from the prediction model P12, and the prediction value output from the prediction model P13. More specifically, the second training unit 23 trains the metamodel MM1 in such a way that the prediction value output from the metamodel MM1 in a case where the prediction values obtained by inputting the feature value group FG of the product 1 to the prediction model group 1 are input to the metamodel MM1 becomes the demand of the product 1 having the features indicated by the plurality of feature values F included in the feature value group FG.

Also for the product 2 belonging to the product group A, as illustrated in FIG. 6, the second training unit 23 trains the metamodel MM1 related to the product group A by using, as training data, the prediction value output from the prediction model P11, the prediction value output from the prediction model P12, and the prediction value output from the prediction model P13.

Similarly for the products 3 and 4 belonging to the product group B, as illustrated in FIG. 6, the second training unit 23 trains the metamodel MM2 related to the product group B by using, as training data, the prediction values output from the prediction model group 2.

### Example of Prediction Result PR Provided by Provision Unit 31

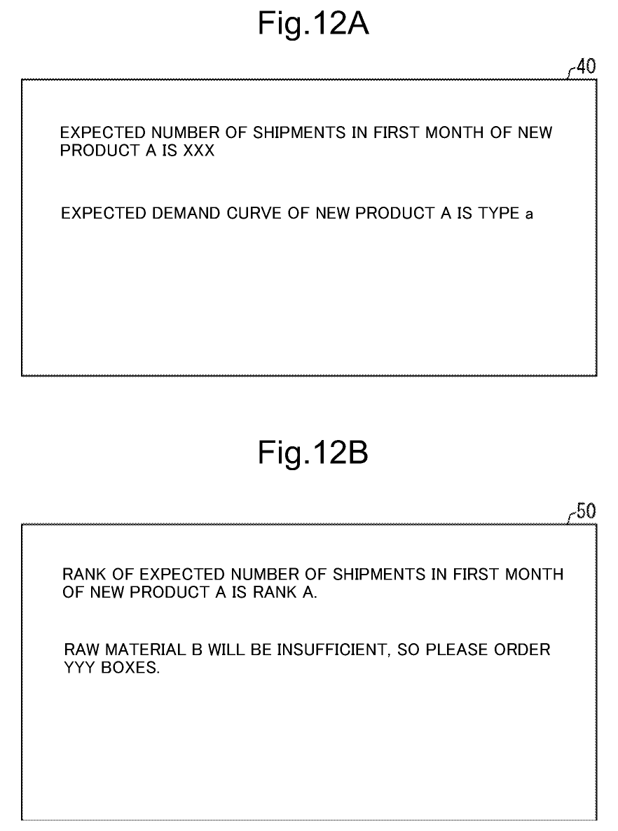

An example of the prediction result PR provided by the provision unit 31 will be described with reference to FIG. 12A and FIG. 12B. FIG. 12A and FIG. 12B are a diagram illustrating an example of the prediction result PR provided by the provision unit 31.

The provision unit 31 may cause the input/output unit 40 to display an image indicating the prediction result PR. For example, as illustrated in FIG. 12A, the input/output unit 40 is caused to display the image indicating the prediction result PR “EXPECTED NUMBER OF SHIPMENTS IN FIRST MONTH OF NEW PRODUCT A IS XXX.” including the expected number of shipments in the first month of the new product A.

In a case where the prediction result PR indicates which predetermined type the expected number of shipments of the new product A in the future is predicted to be classified into, the provision unit 31 causes the input/output unit 40 to display the image indicating the prediction result PR including the classified type “EXPECTED DEMAND CURVE OF NEW PRODUCT A IS TYPE a” as illustrated in FIG. 12A.

The provision unit 31 may provide the prediction result PR to the management device 50. For example, as illustrated in FIG. 12B, in a case where the prediction result PR indicates which predetermined rank the expected number of shipments in the first month of the new product A is predicted to be classified into, the provision unit 31 provides the management device 50 with the prediction result PR “RANK OF EXPECTED NUMBER OF SHIPMENTS IN FIRST MONTH OF NEW PRODUCT A IS RANK A.” including the classified rank. The management device 50 displays the image including the provided prediction result PR.

The management device 50 may display an image including information related to production management of a target product with reference to the prediction result PR. For example, as illustrated in FIG. 12B, in a case where the prediction result PR includes the rank, the management device 50 displays the image including information related to an order of a raw material of the target product “RAW MATERIAL B WILL BE INSUFFICIENT, SO PLEASE ORDER YYY BOXES.” with reference to the rank included in the prediction result PR.

The management device 50 may order the raw material of the target product by using an order system.

In this manner, the provision unit 31 can cause the management device 50 to appropriately manage production of the target product by providing the prediction result PR to the management device 50.

### Effects of Production Management System 100A

As described above, in the production management system 100A, the information processing apparatus 1A inputs the plurality of feature values F related to the target product to the plurality of prediction models PM, and acquires the prediction values output from the plurality of prediction models PM. The information processing apparatus 1A then performs prediction related to the target product by inputting the prediction values to the metamodels MM related to the product similar to the target product.

In this manner, in the production management system 100A, since the information processing apparatus 1A performs prediction related to the target product by inputting the plurality of feature values F related to the target product to the plurality of prediction models PM, prediction related to the product can be performed regardless of conditions.

In the production management system 100A, since the information processing apparatus 1A performs the prediction related to the target product by inputting the prediction values output from the plurality of prediction models PM to the metamodels MM related to the product similar to the target product, prediction related to the target product can be performed with high accuracy.

In the production management system 100A, since the information processing apparatus 1A trains the plurality of prediction models PM and the plurality of metamodels MM, the prediction related to the product can be performed with high accuracy regardless of conditions.

### Third Exemplary Example Embodiment

A third example embodiment that is an example of the example embodiments of the present disclosure will be described in detail with reference to the drawings. Components having the same functions as the components described in the example embodiments described above are denoted by the same reference signs, and description thereof will be appropriately omitted. An application range of each technology adopted in the present example embodiment is not limited to the present example embodiment. That is, each technology adopted in the present example embodiment can also be adopted in another example embodiment included in the present disclosure within a range in which no particular technical problem occurs. Each technology illustrated in each of the drawings referred to for description of the present example embodiment can also be adopted in another example embodiment included in the present disclosure within a range in which no particular technical problem occurs.

### Configuration and Outline of Production Management System 100B

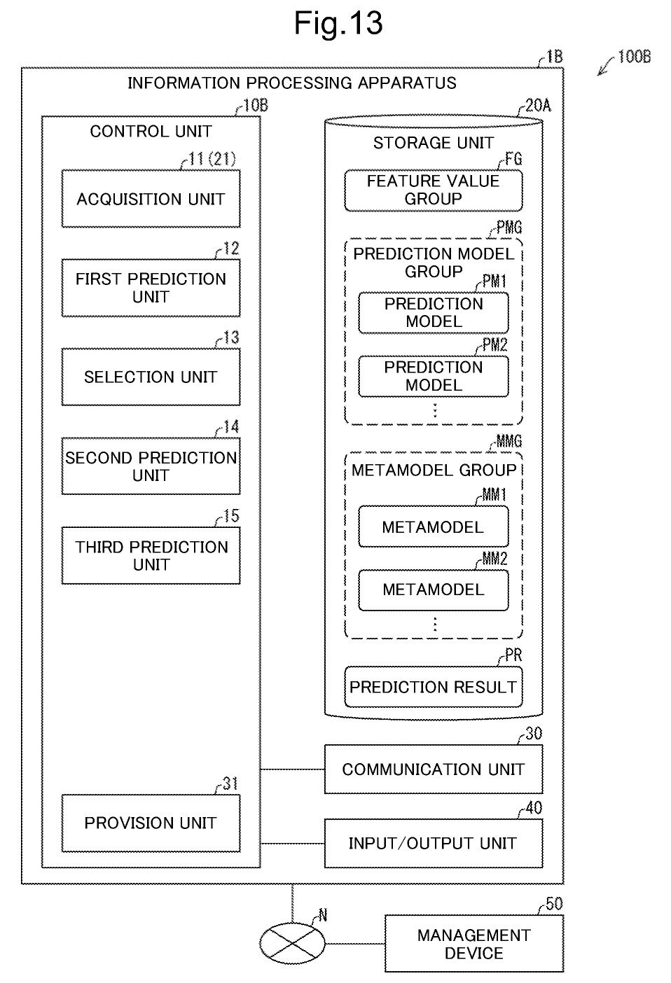

A configuration and an outline of a production management system 100B will be described with reference to FIG. 13. FIG. 13 is a block diagram illustrating the configuration of the production management system 100B. As illustrated in FIG. 13, the production management system 100B includes an information processing apparatus 1B and a management device 50. The information processing apparatus 1B and the management device 50 are communicably connected via a network N.

In the production management system 100B, the information processing apparatus 1B is different from the information processing apparatus 1A in not including the configuration for training the prediction models PM and the metamodels MM included in the information processing apparatus 1A in the production management system 100A described above. Since the management device 50 has the same configuration as that of the management device 50 in the example embodiment described above, description thereof will be omitted.

### Configuration of Information Processing Apparatus 1B

A configuration of the information processing apparatus 1B will be described with reference to FIG. 13 again. As illustrated in FIG. 13, the information processing apparatus 1B includes a control unit 10B, a storage unit 20A, a communication unit 30, and an input/output unit 40. Since the storage unit 20A, the communication unit 30, and the input/output unit 40 have the same configurations as those of the storage unit 20A, the communication unit 30, and the input/output unit 40 in the example embodiment described above, description thereof will be omitted.

### Control Unit 10B

The control unit 10B controls each component included in the information processing apparatus 1B. As illustrated in FIG. 13, the control unit 10B includes an acquisition unit 11 (21), a first prediction unit 12, a selection unit 13, a second prediction unit 14, a third prediction unit 15, and a provision unit 31. The acquisition unit 11 (21), the first prediction unit 12, the selection unit 13, the second prediction unit 14, the third prediction unit 15, and the provision unit 31 achieve acquisition means, first prediction means, selection means, second prediction means, third prediction means, and provision means in the present example embodiment.

Since the acquisition unit 11 (21), the first prediction unit 12, the selection unit 13, the second prediction unit 14, the third prediction unit 15, and the provision unit 31 have the same configurations as those of the acquisition unit 11 (21), the first prediction unit 12, the selection unit 13, the second prediction unit 14, the third prediction unit 15, and the provision unit 31 in the example embodiment described above, description thereof will be omitted.

That is, the configuration of the control unit 10B is the configuration that does not include the first training unit 22 and the second training unit 23 included in the control unit 10A in the example embodiment described above.

### Effect of Production Management System 100B

As described above, in the production management system 100B, the information processing apparatus 1B includes the acquisition unit 11 (21), the first prediction unit 12, the selection unit 13, the second prediction unit 14, the third prediction unit 15, and the provision unit 31 in the example embodiment described above. Therefore, in the production management system 100B, the information processing apparatus 1B can perform prediction related to a product with high accuracy regardless of conditions.

### Achievement Example by Software

Some or all of the functions of the information processing apparatuses 1, 2, 1A, and 1B (hereinafter also referred to as “each of the above apparatuses”) may be achieved by hardware such as an integrated circuit (IC chip) or may be achieved by software.

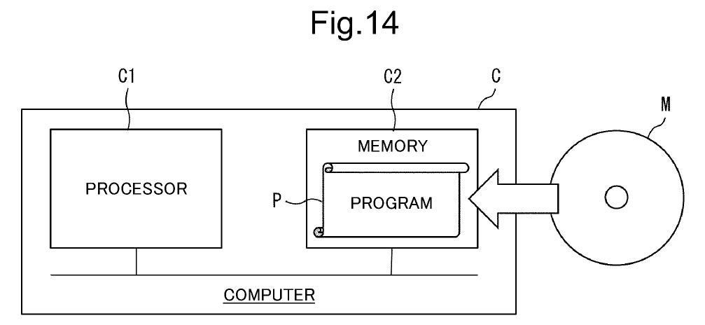

In the latter case, each of the above apparatuses is achieved by, for example, a computer that executes a command of a program as software for achieving each function. An example of such a computer (hereinafter, referred to as a computer C) is illustrated in FIG. 14. FIG. 14 is a block diagram illustrating a hardware configuration of the computer C functioning as each of the above apparatuses.

The computer C includes at least one processor C1 and at least one memory C2. A program P for causing the computer C to operate as each of the above apparatuses is recorded in the memory C2. In the computer C, by the processor C1 reading the program P from the memory C2 and executing the program P, each function of each of the above apparatuses is achieved.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used. As the memory C2, for example, a flash memory, a hard disk drive (HDD), a solid state drive (SSD), or a combination of these can be used.

The computer C may further include a random access memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above apparatuses may be achieved by a single processor provided in a single computer, may be achieved in cooperation with a plurality of processors provided in a single computer, or may be achieved in cooperation with a plurality of processors provided in a plurality of computers. The program for causing each of the above apparatuses to achieve each of the above functions may be stored in a single memory provided in a single computer, may be stored in a distributed manner in a plurality of memories provided in a single computer, or may be stored in a distributed manner in a plurality of memories provided in a plurality of computers.

### Supplementary Note A

The present disclosure includes the technologies described in the following Supplementary Notes. However, the present disclosure is not limited to the technologies described in the following Supplementary Notes, and various modifications can be made within the scope described in the claims.

### Supplementary Note A1

An information processing apparatus including: acquisition means for acquiring a plurality of feature values related to a target product and similar product information related to a product similar to the target product; first prediction means for calculating, by using a plurality of prediction models, a prediction value for each prediction model from the plurality of feature values; selection means for selecting a metamodel related to the similar product information from a plurality of trained metamodels trained for each product group; and second prediction means for performing, by using the selected metamodel, prediction related to the target product from the prediction values calculated by the plurality of prediction models.

### Supplementary Note A2

The information processing apparatus according to Supplementary Note A1, in which each of the plurality of prediction models is a model trained for each feature value group including one or a plurality of feature values.

### Supplementary Note A3

The information processing apparatus according to Supplementary Note A1 or A2, in which the metamodels predict a demand of the target product from the prediction values calculated by the plurality of prediction models.

### Supplementary Note A4

The information processing apparatus according to any one of Supplementary Notes A1 to A3, further including third prediction means for predicting the product similar to the target product and generating the similar product information.

### Supplementary Note A5

The information processing apparatus according to any one of Supplementary Notes A1 to A4, further including provision means for providing a prediction result by the second prediction means to a management device that performs production management of the target product.

### Supplementary Note A6

An information processing apparatus including: acquisition means for acquiring a plurality of feature values related to one or a plurality of products; first training means for training each of a plurality of prediction models for each of a plurality of feature value groups that is selected from the plurality of feature values and that includes one or a plurality of feature values; and second training means for training metamodels that relate to product groups each including one or a plurality of products and that perform prediction related to a target product with reference to output of the plurality of prediction models, with reference to output from the prediction models related to a plurality of feature value groups selected from a plurality of feature values related to the one or plurality of products included in the product group.

### Supplementary Note A7

The information processing apparatus according to Supplementary Note A6, in which, in training processing by the second training means, one or a plurality of feature values included in each of the plurality of feature value groups selected from the plurality of feature values related to the one or plurality of products included in the product group is input to each of the plurality of prediction models.

### Supplementary Note B

The present disclosure includes the technologies described in the following Supplementary Notes. However, the present disclosure is not limited to the technologies described in the following Supplementary Notes, and various modifications can be made within the scope described in the claims.

### Supplementary Note B1

An information processing method including: acquisition processing of acquiring, by at least one processor, a plurality of feature values related to a target product and similar product information related to a product similar to the target product; first prediction processing of calculating, by the at least one processor, a prediction value for each prediction model from the plurality of feature values, by using a plurality of prediction models; selection processing of selecting, by the at least one processor, a metamodel related to the similar product information from a plurality of trained metamodels trained for each product group; and second prediction processing of performing, by the at least one processor, prediction related to the target product from the prediction values calculated by the plurality of prediction models, by using the selected metamodel.

### Supplementary Note B2

The information processing method according to Supplementary Note B1, in which each of the plurality of prediction models is a model trained for each feature value group including one or a plurality of feature values.

### Supplementary Note B3

The information processing method according to Supplementary Note B1 or B2, in which the metamodels predict a demand of the target product from the prediction values calculated by the plurality of prediction models.

### Supplementary Note B4

The information processing method according to any one of Supplementary Notes B1 to B3, further including third prediction processing of predicting the product similar to the target product and generating the similar product information, by the at least one processor.

(Supplementary Note B5)

The information processing method according to any one of Supplementary Notes B1 to B4, further including provision processing of providing, by the at least one processor, a prediction result by the second prediction processing to a management device that performs production management of the target product.

### Supplementary Note B6

An information processing method including: acquisition processing of acquiring, by at least one processor, a plurality of feature values related to one or a plurality of products; first training processing of training, by the at least one processor, each of a plurality of prediction models for each of a plurality of feature value groups that is selected from the plurality of feature values and that includes one or a plurality of feature values; and second training processing of training, by the at least one processor, metamodels that relate to product groups each including one or a plurality of products and that perform prediction related to a target product with reference to output of the plurality of prediction models, with reference to output from the prediction models related to a plurality of feature value groups selected from a plurality of feature values related to the one or plurality of products included in the product group.

### Supplementary Note B7

The information processing method according to Supplementary Note B6, in which, in training processing by the second training processing, one or a plurality of feature values included in each of the plurality of feature value groups selected from the plurality of feature values related to the one or plurality of products included in the product group is input to each of the plurality of prediction models.

### Supplementary Note C

The present disclosure includes the technologies described in the following Supplementary Notes. However, the present disclosure is not limited to the technologies described in the following Supplementary Notes, and various modifications can be made within the scope described in the claims.

### Supplementary Note C1

An information processing program for causing a computer to function as an information processing apparatus, the computer being caused to function as: acquisition means for acquiring a plurality of feature values related to a target product and similar product information related to a product similar to the target product; first prediction means for calculating, by using a plurality of prediction models, a prediction value for each prediction model from the plurality of feature values; selection means for selecting a metamodel related to the similar product information from a plurality of trained metamodels trained for each product group; and second prediction means for performing, by using the selected metamodel, prediction related to the target product from the prediction values calculated by the plurality of prediction models.

### Supplementary Note C2

The information processing program according to Supplementary Note C1, in which each of the plurality of prediction models is a model trained for each feature value group including one or a plurality of feature values.

### Supplementary Note C3

The information processing program according to Supplementary Note C1 or C2, in which the metamodels predict a demand of the target product from the prediction values calculated by the plurality of prediction models.

### Supplementary Note C4

The information processing program according to any one of Supplementary Notes C1 to C3, for causing the computer to function as third prediction processing of predicting the product similar to the target product and generating the similar product information.

### Supplementary Note C5

The information processing program according to any one of Supplementary Notes C1 to C4, for causing the computer to function as provision processing of providing a prediction result by the second prediction means to a management device that performs production management of the target product.

### Supplementary Note C6

An information processing program for causing a computer to function as an information processing apparatus, the computer being caused to function as: acquisition means for acquiring a plurality of feature values related to one or a plurality of products; first training means for training each of a plurality of prediction models for each of a plurality of feature value groups that is selected from the plurality of feature values and that includes one or a plurality of feature values; and second training means for training metamodels that relate to product groups each including one or a plurality of products and that perform prediction related to a target product with reference to output of the plurality of prediction models, with reference to output from the prediction models related to a plurality of feature value groups selected from a plurality of feature values related to the one or plurality of products included in the product group.

### Supplementary Note C7

The information processing program according to Supplementary Note C6, in which, in training processing by the second training means, one or a plurality of feature values included in each of the plurality of feature value groups selected from the plurality of feature values related to the one or plurality of products included in the product group is input to each of the plurality of prediction models.

### Supplementary Note D

The present disclosure includes the technologies described in the following Supplementary Notes. However, the present disclosure is not limited to the technologies described in the following Supplementary Notes, and various modifications can be made within the scope described in the claims.

### Supplementary Note D1

An information processing apparatus including at least one processor, the at least one processor executing: acquisition processing of acquiring a plurality of feature values related to a target product and similar product information related to a product similar to the target product; first prediction processing of calculating, by using a plurality of prediction models, a prediction value for each prediction model from the plurality of feature values; selection processing of selecting a metamodel related to the similar product information from a plurality of trained metamodels trained for each product group; and second prediction processing of performing, by using the selected metamodel, prediction related to the target product from the prediction values calculated by the plurality of prediction models.

The information processing apparatus may further include a memory. The memory may store a program for causing the at least one processor to execute each type of the processing.

### Supplementary Note D2

The information processing apparatus according to Supplementary Note D1, in which each of the plurality of prediction models is a model trained for each feature value group including one or a plurality of feature values.

### Supplementary Note D3

The information processing apparatus according to Supplementary Note D1 or D2, in which the metamodels predict a demand of the target product from the prediction values calculated by the plurality of prediction models.

### Supplementary Note D4

The information processing apparatus according to any one of Supplementary Notes D1 to D3, in which the at least one processor executes third prediction processing of predicting the product similar to the target product and generating the similar product information.

### Supplementary Note D5

The information processing apparatus according to any one of Supplementary Notes D1 to D4, in which the at least one processor executes provision processing of providing a prediction result by the second prediction processing to a management device that performs production management of the target product.

### Supplementary Note D6

An information processing apparatus including at least one processor, the at least one processor executing: acquisition processing of acquiring a plurality of feature values related to one or a plurality of products; first training processing of training each of a plurality of prediction models for each of a plurality of feature value groups that is selected from the plurality of feature values and that includes one or a plurality of feature values; and second training processing of training metamodels that relate to product groups each including one or a plurality of products and that perform prediction related to a target product with reference to output of the plurality of prediction models, with reference to output from the prediction models related to a plurality of feature value groups selected from a plurality of feature values related to the one or plurality of products included in the product group.

### Supplementary Note D7

The information processing apparatus according to Supplementary Note D6, in which, in training processing by the second training processing, one or a plurality of feature values included in each of the plurality of feature value groups selected from the plurality of feature values related to the one or plurality of products included in the product group is input to each of the plurality of prediction models.

### Supplementary Note E

The present disclosure includes the technologies described in the following Supplementary Notes. However, the present disclosure is not limited to the technologies described in the following Supplementary Notes, and various modifications can be made within the scope described in the claims.

### Supplementary Note E1

A non-transitory recording medium recording an information processing program for causing a computer to function as an information processing apparatus, the computer being caused to execute: acquisition processing of acquiring a plurality of feature values related to a target product and similar product information related to a product similar to the target product; first prediction processing of calculating, by using a plurality of prediction models, a prediction value for each prediction model from the plurality of feature values; selection processing of selecting a metamodel related to the similar product information from a plurality of trained metamodels trained for each product group; and second prediction processing of performing, by using the selected metamodel, prediction related to the target product from the prediction values calculated by the plurality of prediction models.

### Supplementary Note E2

A non-transitory recording medium recording an information processing program for causing a computer to function as an information processing apparatus, the computer being caused to execute: acquisition processing of acquiring a plurality of feature values related to one or a plurality of products; first training processing of training each of a plurality of prediction models for each of a plurality of feature value groups that is selected from the plurality of feature values and that includes one or a plurality of feature values; and second training processing of training metamodels that relate to product groups each including one or a plurality of products and that perform prediction related to a target product with reference to output of the plurality of prediction models, with reference to output from the prediction models related to a plurality of feature value groups selected from a plurality of feature values related to the one or plurality of products included in the product group.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor’s intent is to retain all equivalents of the claimed invention even if the claims are amended during prosecution.

1. An information processing apparatus comprising:
at least one memory storing instructions; and
at least one processor configured to execute the instructions to:
acquire a plurality of feature values related to a target product and similar product information related to a product similar to the target product;
calculate a prediction value for each prediction model from the plurality of feature values, using a plurality of prediction models;
select a metamodel related to the similar product information from a plurality of trained metamodels trained for each product group; and
perform prediction related to the target product from the prediction values calculated by the plurality of prediction models, using the selected metamodel.

2. The information processing apparatus according to claim 1, wherein each of the plurality of prediction models is a machine learning model trained for each feature value group including one or a plurality of feature values.

3. The information processing apparatus according to claim 2, wherein the selected metamodel predicts a demand of the target product from the prediction values calculated by the plurality of prediction models.

4. The information processing apparatus according to claim 3, wherein the at least one processor is further configured to execute the instructions to:
predict a product similar to the target product and generate the similar product information.

5. The information processing apparatus according to claim 1, wherein the at least one processor is further configured to execute the instructions to:
provide a prediction result by the selected metamodel to a management device that performs production management of the target product.

6. The information processing apparatus according to claim 1, wherein the at least one processor is further configured to execute the instructions to:
output the prediction related to the target product to a management device to support a user's decision making regarding production management of the target product.

7. An information processing apparatus comprising:
at least one memory storing instructions; and
at least one processor configured to execute the instructions to:
acquire a plurality of feature values related to one or a plurality of products;
train each of a plurality of prediction models for each of a plurality of feature value groups selected from the plurality of feature values, each of a plurality of feature value groups including one or a plurality of feature values; and
train metamodels related to product groups each including one or a plurality of products, the metamodels performing prediction related to a target product with reference to output of the plurality of prediction models, the plurality of prediction models being related to a plurality of feature value groups selected from a plurality of feature values related to the one or plurality of products included in the product group.

8. An information processing method comprising:
by at least one processor,
acquiring a plurality of feature values related to a target product and similar product information related to a product similar to the target product;
calculating a prediction value for each prediction model from the plurality of feature values, using a plurality of prediction models;
selecting a metamodel related to the similar product information from a plurality of trained metamodels trained for each product group; and
performing prediction related to the target product from the prediction values calculated by the plurality of prediction models, using the selected metamodel.
